(19) United States
(12) Patent Application Publication
(10) Pub. No.: US 2010/0222207 A1
(43) Pub. Date: Sep. 2, 2010

(54) METHOD OF SYNTHESIZING SILICON CARBIDE MATERIALS FROM SILICON BASED POLYMERS

(75) Inventors: Akira IDESAKI, Takasaki (JP); Masaki SUGIMOTO, Takasaki (JP); Ryoji TANAKA, Takasaki (JP); Masahito YOSHIKAWA, Takasaki (JP)

Correspondence Address: BRUNDIDGE & STANGER, P.C., 2318 MILL ROAD, SUITE 1020, ALEXANDRIA, VA, 22314, US

(73) Assignee: Japan Atomic Energy Agency, Ibaraki (JP)

(21) Appl. No.: 12/712,708

(22) Filed: Feb. 25, 2010

(30) Foreign Application Priority Data
Feb. 27, 2009 (JP) 2009-046288

(51) Int. Cl. B01J 31/06; B01J 31/02; B01J 31/12

(52) U.S. Cl. 502/152; 502/159; 502/158

(57) ABSTRACT

A method of synthesizing SiC materials comprising the step of making a blend which consists of a silicon based polymer and a metal complex by blending a silicon based polymer solution and a metal complex solution and drying, and firing the blend in an inert gas at 700° C. or more; and a SiC ceramic material which has catalyst performance in which a CO gas is oxidized to generate a CO₂ gas, made by blending a polycarbosilane solution and a palladium acetate solution, and firing the blend in an inert gas at 700° C. or more after drying.

### BACKGROUND OF THE INVENTION

The present invention relates to silicon carbide (SiC) materials having a high hardness, a high heat resistance and a high durability, especially to a method of synthesizing silicon carbide materials having catalyst performance in high yields from silicon based polymers.

Generally, silicon based polymer is used as a starting material by which a SiC fiber and a SiC gas separator membrane are manufactured. However, the rate of weight converted to SiC materials (SiC yield) is about 60% and low. On the other hand, as described in JP2006-124257A and JP2007-76950A for instance, the technology which improves SiC yield up to about 80% by the radiation crosslinking of silicon based polymers or by the thermal oxidation crosslinking thereof has already been developed.

When seeing from aspects of ceramic materials which have catalyst performance, silica (SiO₂) materials on catalysts have actively been developed by the sol-gel process in the field of the gas separation technology.

### BRIEF SUMMARY OF THE INVENTION

However, in the above-mentioned thermal oxidation crosslinking, when heat-treating it, the temperature should be kept constant because the oxidation crosslinking reaction of silicon based polymers undergoes an exothermic reaction. It is, therefore, difficult technically to obtain uniform crosslinking. On the other hand, the radiation facilities are necessary for crosslinking though the uniform crosslinking can be achieved in the radiation crosslinking. Therefore, there is a problem with a high manufacturing cost.

Moreover, for silica (SiO₂) material on catalysts by the above-mentioned sol-gel process, an oxide system ceramic material like SiO₂ material is inferior in a heat resistance, a chemical resistance, and a steam resistance compared with a non-oxide system ceramic material like SiC material. Therefore, the use under extremely environmental conditions such as a high temperature, a strong acid, a strong alkalis, and high temperature steams is restricted.

An object of the present invention is to provide a method of synthesizing easily SiC materials in high yields and at low cost compared with the prior art.

In addition, another object of the present invention is to provide a method of synthesizing SiC materials which have catalyst performance by using metal complex which contains transition metal as a starting material, and SIC ceramic materials manufactured thereby.

The inventors found happening of the crosslinking of silicon based polymers when the blend consisted of silicon based polymers and metal complexes was made. And, they clarified that SIC yield which is about 60% so far is improved up to 80% by firing the obtained blend in an inert gas. In addition, they found that the synthesized SIC material shows catalyst performance by using metal complexes which contain transition metal.

Concretely, a method of synthesizing SIC materials according to an aspect of the present invention is characterized by making the blend which consists of silicon based polymers and metal complexes, and firing the blend in an inert gas.

Moreover, according to another aspect of the present invention, an SIC material synthesizing of the present invention is characterized by obtaining SIC ceramic materials which have catalyst performance by blending a silicon based polymer solution and a metal complex solution which contains transition metal, and firing the blend in an inert gas at 700° C. or more after drying.

According to the present invention, SIC materials can be synthesized in high yields from a silicon based polymer in a simple and inexpensive method in which a silicon based polymer solution and a metal complex solution which contains transition metal are blended, dried and fired. In addition, synthesizing SiC materials which have catalyst performance becomes possible by using metal complex which contains transition metal. By now, SiC materials which have catalyst performance have not been developed. Therefore, the realization of ceramic materials on catalysts, which can be replaced oxide system ceramic materials used so far, and which can be used under extreme environmental conditions is expected.

### BRIEF DESCRIPTION OF THE SEVERAL VIEWS OF THE DRAWINGS

FIG. 1 is a flow chart illustrating a process according to the present invention where SiC materials or SiC materials on catalysts is synthesized in high yields.

FIG. 2 is a graph showing change in weight of the blend of polycarbosilane and palladium acetate, in which a state from the room temperature up to 1200° C. under a helium atmosphere is shown.

FIG. 3 is an illustration of catalyst performance by which a CO gas is oxidized to generate a CO₂ gas in SiC materials synthesized from polycarbosilane and palladium acetate.

### DETAILED DESCRIPTION OF THE PREFERRED EMBODIMENTS

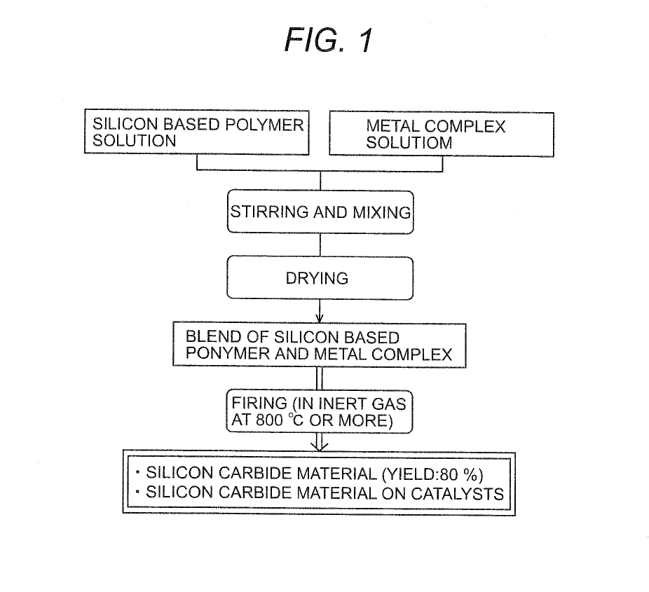

FIG. 1 shows a process of the present invention where SiC materials or SiC materials on catalysts are synthesized in high yields.

First, a solvent is prepared, which can dissolve both of silicon based polymer and metal complex, and each of silicon based polymer and metal complex are made a solution. Next, a blend of silicon based polymer and metal complex is obtained by drying after blending their solutions while stirring.

The above-mentioned blend can be made in an arbitrary composition ratio. Moreover, a crosslinking reaction is occurred between Si—H bonds of silicon based polymers and acetate ions of metal complex when the blend is made. The more the coordination number in metal complexes, and/or the more the number of Si—H bonds in the unit structure of silicon based polymers, the easier the crosslinking reaction occurs. Therefore, SiC materials can be synthesized in higher yields by selecting the material having such a characteristic.

Finally, SiC materials are synthesized by firing the obtained blend in an inert gas such as argon or helium at the temperature of 700° C. or more. SiC materials which have catalyst performance can be synthesized by using metal complexes which contain transition metal as a starting material. The most suitable firing temperature is 1200° C.

### Embodiment 1

Each of 200 mg of polycarbosilane (PCS) as silicon based polymers and 200 mg of palladium acetate (Pd(OAc)₂) as metal complexes were dissolved in 100 ml of tetrahydrofuran (THF) separately. Here, the chemical structure of polycarbosilane (PCS) is expressed by the following chemical formula, which contains one Si—H bonds in the unit structure. The above-mentioned amount of PCS, Pd(OAc)₂, or THF is one example, and a similar blend can be obtained even if a different amount of PCS, Pd(OAc)₂, or THF is used.

—CH₂-Si(CH₃)₂)m—(CH₂—SiH(CH₃))m′—

Where m/m′=1

PCS solution was poured into the flask, and Pd(OAc)₂ solution was injected while stirring the PCS solution. This operation was carried out at the room temperature. Afterwards, THF has volatilized by using a rotary evaporator. At this time, vacuum drying was carried out for about an hour to volatize THF enough.

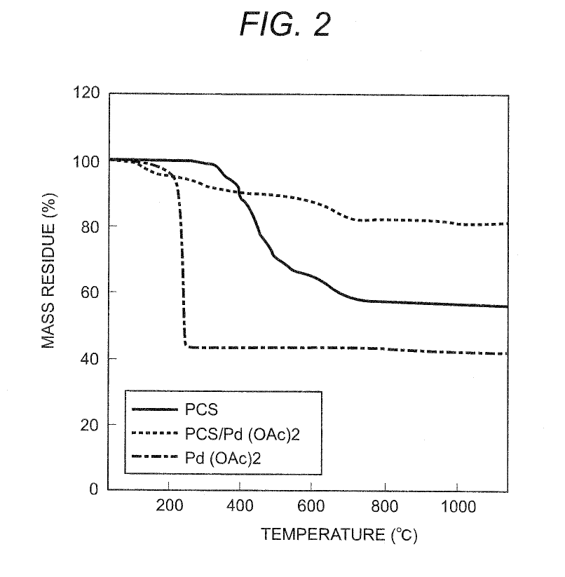

The obtained blend was fired from the room temperature up to 1200° C. under a helium atmosphere. The result of examining the weight change at that time is shown in FIG. 2. A solid line shows the result of PCS unit, an alternate long and short dash line shows the result of Pd(OAc)₂ unit, and a dotted line shows the result of PCS/Pd(OAc)₂ blend. This blend was made by a composition ratio that PCS/Pd(OAc)₂ becomes 1/0.8 in weight ratio.

As a result, it was clarified that while SiC yield from the unprocessed PCS is 60%, SiC yield from the blend of PCS and Pd(OAc)₂ can be improved up to 80%. Now, from the result given by the SiC yield improvement technology by the conventional thermal oxidation crosslinking and radiation crosslinking, it has already been understood that SiC yield rises when the crosslinking of silicon based polymers is caused. Therefore, the result shown in FIG. 2 suggests that the reaction which occurs between PCS and Pd(OAc)₂ is a crosslinking reaction.

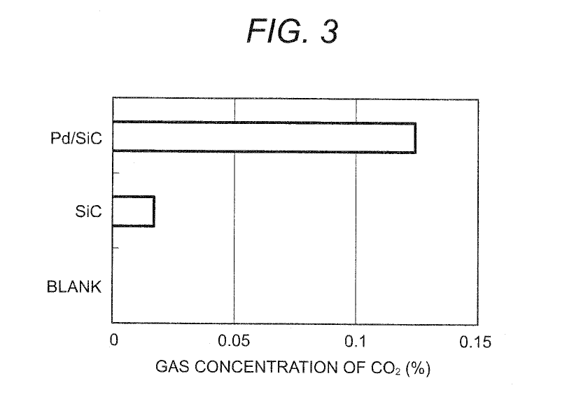

The results analyzed a mixed gas after the obtained SiC materials are heat-treated for an hour under a mixed gas atmosphere of 0.2% CO-2% O₂-97.8%N₂ at 200° C. is shown in FIG. 3. The horizontal axis of FIG. 3 shows gas concentration (%) of CO₂. Blank in figure shows the result of having analyzed the gas after only the mixed gas is heat-treated without using a sample. SiC shows the result obtained by using SiC materials synthesized only from PCS. And, Pd/SiC shows the result obtained by using SiC materials synthesized from the blend of PCS and Pd(OAc)₂. As clearly seen from this figure, the SiC materials synthesized from PCS and Pd(OAc)₂ showed catalyst performance in which a CO gas is oxidized to generate a CO₂ gas.

What is claimed is:

1. A method of synthesizing SiC materials comprising the steps of:
making a blend which consists of a silicon based polymer and a metal complex; and
firing the blend in an inert gas.

2. The method according to claim 1, wherein
said silicon based polymer contains one or more Si-H bonds in unit structure.

3. The method according to claim 1, wherein
said metal complex contains at least one metal acetate selected from the group consisting of palladium acetate, cobalt acetate, nickel acetate, and rhodium acetate.

4. The method according to claim 1, wherein
central metal of said metal complex is transition metal selected from the group consisting of palladium, cobalt, nickel and so on.

5. A method of synthesizing SiC materials comprising the step of:
making a blend which consists of a silicon based polymer and a metal complex by blending a silicon based polymer solution and a metal complex solution and drying; and
firing the blend in an inert gas at 700° C. or more.

6. The method according to claim 5, wherein
said silicon based polymer contains one or more Si-H bonds in unit structure.

7. The method according to claim 5, wherein
said metal complex contains at least one metal acetate selected from the group consisting of palladium acetate, cobalt acetate, nickel acetate, and rhodium acetate.

8. The method according to claim 5, wherein
central metal of said metal complex is transition metal selected from the group consisting of palladium, cobalt, nickel and so on.

9. A SiC ceramic material which has catalyst performance made by blending a silicon based polymer solution and a metal complex solution which contains transition metal, and firing the blend in an inert gas at 700° C. or more after drying.

10. A SiC ceramic material which has catalyst performance in which a CO gas is oxidized to generate a CO₂ gas, made by blending a polycarbosilane solution and a palladium acetate solution, and firing the blend in an inert gas at 700° C. or more after drying.
